(19) United States
(12) Patent Application Publication
(10) Pub. No.: US 2007/0294184 A1
(43) Pub. Date: Dec. 20, 2007

(54) METHOD AND SYSTEM FOR ENHANCED CONSUMER PAYMENT

(76) Inventors: Timothy Mu-Chu Lee, Singapore (SG); Gary E. Gerber, Foster City, CA (US)

Correspondence Address: MAYER BROWN LLP, P.O. BOX 2828, CHICAGO, IL, 60690, US

(21) Appl. No.: 11/696,994

(22) Filed: Apr. 5, 2007

Related U.S. Application Data
(60) Provisional application No. 60/744,297, filed on Apr. 5, 2006.

(51) Int. Cl. G06Q 30/00; H04L 9/32

(52) U.S. Cl. 705/67; 705/78

(57) ABSTRACT

Disclosed herein is a system for processing a purchase comprising a merchant for providing to a consumer an electronic shopping cart, providing to a consumer a prompt to enter a consumer identifier, and submitting content of the shopping cart and the consumer identifier for payment and a service platform for storing the consumer's payment information, receiving the content of the shopping cart and the consumer identifier, authenticating the consumer's the payment information, processing payment for the content of the shopping cart using the consumer's payment information, and sending confirmation of payment to the merchant.

### REFERENCE TO RELATED APPLICATIONS

The present application claims priority to U.S. application Ser. No. 60/744,297, filed Apr. 5, 2006, and entitled “METHODS AND SYSTEMS FOR ENHANCED CONSUMER PAYMENT,” which is incorporated by reference herein.

### BACKGROUND

Financial transactions, such as credit transactions, debit transactions, loyalty card transactions and the like, rely on message and data exchanges between participants (e.g., members, merchants, associations and users). Traditionally, such transactions have been performed over private networks and have used proprietary protocols, which reduced the likelihood that transactions were compromised.

The Internet and other more recently utilized access devices, such as mobile phones, PDAs, vending machines, set-top boxes and the like, have offered added convenience for users desiring to perform transactions. The number of such electronic commerce transactions is growing as a result. In connection with this growth trend, the threat from fraudulent transactions over the Internet or in conjunction with such access devices is also likely to increase.

For example, when data, such as a card number, expiration date, data contained on a token and/or cardholder personal data, is transmitted over a network, an unauthorized individual could intercept the data. The individual might attempt to use the intercepted data to perform a subsequent fraudulent transaction. Similarly, data provided by a consumer to a merchant might be used by the merchant and/or an employee of the merchant to perform a subsequent fraudulent transaction. Data that a cardholder did not intend to be publicly available can be obtained in other ways as well.

Accordingly, participants in payment transactions, such as payment processors, consumers, issuers, merchants and the like, have sought to reduce the amount of transaction-specific and/or participant-specific information that is transferred during a transaction and is readable by an intercepting party. As such, payment processors may verify a transaction based on publicly available information, dynamically changing information, and/or encrypted information.

One problem with conventional proprietary payment processing operations is that payment processors and/or merchants perform such operations independently of authentication providers and data providers. As such, the payment processors and/or merchants are typically required to possess all authentication data for a consumer. Obtaining this information requires the consumer, or a party to whom the consumer has provided information, to make the information available to the payment processor. Accordingly, the data may be intercepted at the time it is made available to the payment processor.

Another problem facing payment processors is that they do not have access to consumer history data that could be used to enhance a purchasing experience. Although a merchant may have access to consumer purchases made with the merchant, the merchant might not know of a particular consumer purchasing need based on purchases made at a different merchant because the merchant does not have access to a complete consumer purchasing history. Likewise, the consumer might not be aware that the merchant provides certain goods or services that could be of use to the consumer in conjunction with prior purchases from the merchant and/or another merchant. As such, neither the consumer nor the merchant may realize the maximum possible benefit from the transaction.

Another problem is that payment processors lack the ability to perform buy-time initiated escrow functions. Conventionally, payment processors perform non-face-to-face (i.e., remote) transactions in either a pull model in which the merchant initiates a payment card transaction, or a push model where consumers pay the merchant “cash on the table.” In either case, one party assumes all of the risk for the transaction and has no assurance that the other party will complete their portion of the transaction. Providing an escrow service removes the possibility for either party to defraud the other during the transaction.

Numerous problems limit the use of escrow services in consumer transactions. For example, escrow services have conventionally required selection of a third party escrow service and agreement between the consumer and merchant to use escrow services. Accordingly, use of such escrow services requires significant discussion between the parties that typically does not occur. Moreover, automatically inserting an escrow service in a payment process is infeasible using conventional payment processors even if such services are desired by one or more of the parties. An additional problem with conventional escrow services is that they can be confusing and expensive to use. Consumers are also typically unaware that escrow services are available for transactions. In general, inconsistent use of escrow services can result in increased fraud exposure for both consumers and merchants.

Payment processors also typically do not provide a merchant with the opportunity to automatically enroll a consumer in a service as part of a transaction. In conventional online enrollment processes, the consumer could be asked to enroll at a separate enrollment site. Alternately, a consumer could be transferred by a merchant or a payment processor on behalf of a merchant to a separate enrollment site. The consumer is then requested to supply information to enroll with the site. Such a process is cumbersome for both the consumer and the merchant because the consumer must perform significant additional data entry and the merchant must provide a way to access and return from the enrollment site. Because the consumer enters information that was already made available to the merchant, the possibility that the information is intercepted increases. In addition, the merchant is disadvantaged because the consumer is now no longer located at the merchant website and can more easily abandon the transaction.

Yet another problem with enrollment at conventional enrollment sites is that such sites can only enroll consumers that opt to enroll. Accordingly, consumer information that is obtained via conventional enrollment sites is limited as compared to the information that could be obtained if enrollment were automatically performed.

Conventional payment processors require consumers to submit a particular identifier, such as an email address, that is specified by a merchant or the payment processing service in order to identify a consumer. However, the consumer might not desire to supply an identifier of that type. For example, some consumers might not have an identifier of the particular type requested (e.g., the consumer might not have an email address). Moreover, the consumer might not desire to provide a specific type of identifier due to privacy and/or security concerns (e.g., the consumer might not want to provide an email address to a merchant based on a belief that the merchant might use it to generate a mailing list). The consumer might remember a particular type of identifier more easily than a requested identifier (e.g., the consumer might remember an email address more easily than a credit card number). Furthermore, a particular type of identifier might be sub-optimal for a particular channel (e.g., an email address may be appropriate when purchasing goods over the Internet, but may be cumbersome when purchasing via a mobile phone). Other reasons for using one type of identifier over another are possible as well.

Payment processors also do not typically permit a consumer to transfer a balance from one payment system to another. Conventional services storing balances of funds or trading/bartering value are only able to use stored balances or funds for actual purchases. Extracting value from such systems into external systems, such as bank accounts or disbursement checks, has been a cumbersome process, if such processes have been available at all.

What is needed is a method and system for performing a transaction that limits the amount of information required to be transferred during the transaction.

A need exists for a method and system for restricting the amount of sensitive information made available to the merchant or an unauthorized third party during a transaction.

A need exists for a method and system for automatically enrolling a consumer in a service as part of a transaction process.

A need exists for a method and system for providing enhanced historical data to a merchant during a transaction to enable cross-selling and otherwise meet the needs of the consumer.

A need exists for a method and system for providing flexible authentication to a consumer based upon the payment method and type of verification permitted by the consumer.

A further need exists for a method and system for providing an escrow service automatically for a payment transaction using a service platform.

The present disclosure is directed to solving one or more of the above-listed problems.

### SUMMARY

Before the present methods are described, it is to be understood that this invention is not limited to the particular methodologies or protocols described, as these may vary. It is also to be understood that the terminology used herein is for the purpose of describing particular embodiments only, and is not intended to limit the scope of the present disclosure, which will be limited only by the appended claims.

It must be noted that as used herein and in the appended claims, the singular forms “a,” “an,” and “the” include plural reference unless the context clearly dictates otherwise. Thus, for example, reference to a “transaction” is a reference to one or more transactions and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of the present invention, the preferred methods, devices, and materials are now described. All publications mentioned herein are incorporated herein by reference. Nothing herein is to be construed as an admission that the invention is not entitled to antedate such disclosure by virtue of prior invention.

A service platform may facilitate payment transactions when a consumer shops at any of a plurality of enrolled merchants. The service platform may be provided by the bank with which the consumer maintains a transaction card account and/or by the association that operated the transaction card account system, such as Visa, MasterCard, American Express and the like. Numerous advantages may result from the operation of the service platform. A merchant may receive enhanced data regarding the consumer from the service platform when performing a transaction because the data may include consumer information retrieved from each enrolled merchant. In addition, the service platform may perform an authentication process for the transaction, which may eliminate the need for the merchant to provide such services. Transactions performed using the service platform may exhibit enhanced privacy because sensitive information may be stored only at the service platform and may not be communicated to the merchant or via an insecure data channel. Enhanced privacy and security may result because the information required to process the transaction has already been made available to the service platform as part of the enrollment process for obtaining the transaction card. In addition, the consumer may be required to submit less information during a transaction because particular information, such as shipping addresses, may be stored at the service platform. The service platform may also provide an escrow service that enables the merchant and the consumer to verify that the transaction completes appropriately.

An additional feature of the service platform may include automatic enrollment in which the consumer is automatically enrolled in the service platform when first performing a transaction with a participating merchant. The automatic enrollment may be performed using information that is typically provided by a consumer during a financial transaction. Such an enrollment process may be used to enroll a consumer in a payment service and/or any other service using such information.

Other advantages may include flexibility in selecting an authentication mechanism, flexibility in selecting a consumer identifier, and the ability to offer balance transfer promotions to a consumer automatically during the payment process. These and other advantages may result in a more streamlined checkout process.

### BRIEF DESCRIPTION OF THE DRAWINGS

Aspects, features, benefits and advantages of the present invention will be apparent with regard to the following description and accompanying drawings, of which:

FIG. 1 depicts a flow diagram for an exemplary method of facilitating a financial transaction according to an embodiment.

FIG. 2 depicts a flow diagram for an alternate exemplary method of facilitating a financial transaction according to an embodiment.

FIG. 3A depicts a flow diagram for an exemplary automatic enrollment process during a financial transaction according to an embodiment.

FIG. 3B depicts a flow diagram for an exemplary financial transaction after automatic enrollment has been performed according to an embodiment.

FIG. 4 depicts a flow diagram for an exemplary method of providing consumer purchase history data to a merchant during a financial transaction according to an embodiment.

FIG. 5 depicts a flow diagram for an exemplary method of determining an authentication service for a transaction according to an embodiment.

FIG. 6 depicts a flow diagram for an exemplary method of automatically providing an escrow function for a transaction according to an embodiment.

### DETAILED DESCRIPTION

As used herein, a token may include, for example and without limitation, a transaction card and/or a portable device that contains information used to perform a transaction, such as a primary account number, a name of a cardholder/tokenholder and the like.

A transaction card may include, for example and without limitation, a credit card, a debit card, a smart card, a loyalty card and the like.

A portable device may include, for example and without limitation, a personal digital assistant, a cellular phone, or any other device that contains information used for performing a transaction.

In an embodiment, a service platform may be hosted directly by a merchant or may be operated as a hosted service on the merchant's behalf. If a consumer has enrolled with the service platform, the service may facilitate a streamlined checkout process. If the consumer has not enrolled, the service may allow a traditional checkout process to occur and may automatically enroll the consumer in the service during the checkout process. In this manner, the consumer may engage in a streamlined transaction using the service platform when the consumer performs subsequent transactions with the merchant or another participating merchant.

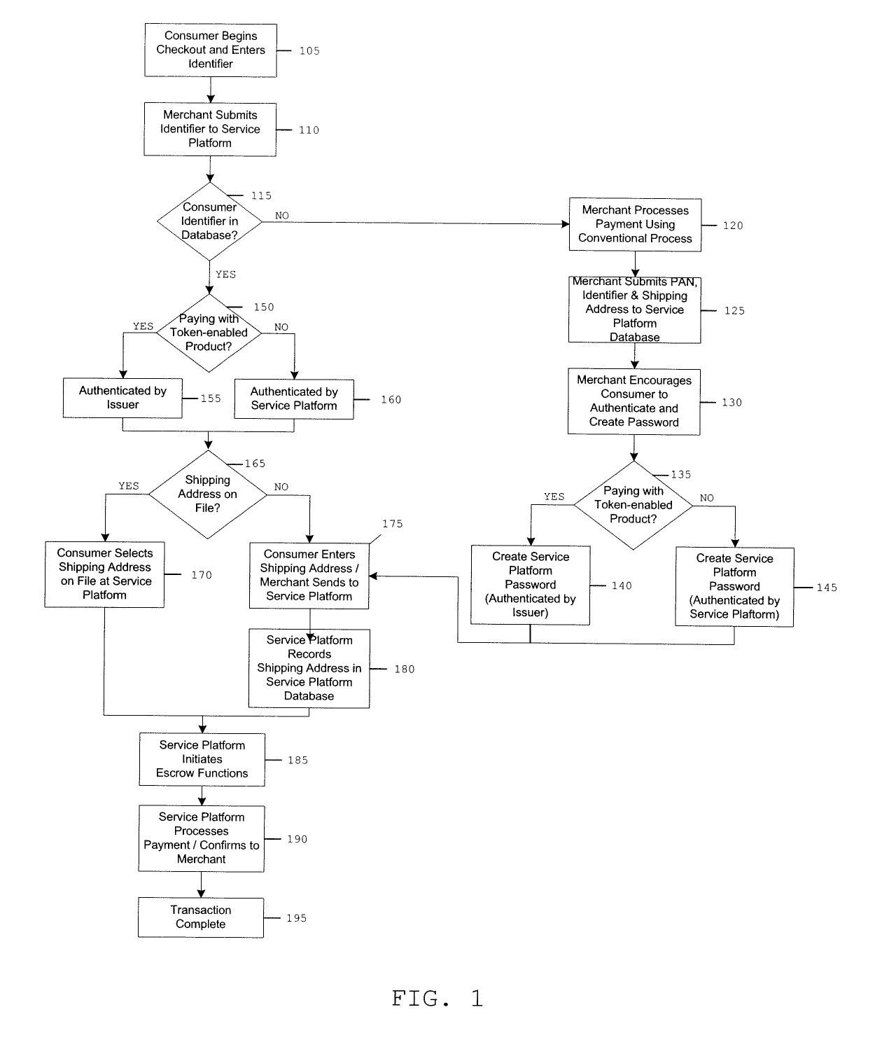

FIG. 1 depicts a flow diagram for an exemplary method of facilitating a financial transaction according to an embodiment. As shown in FIG. 1, a consumer may initiate 105 a transaction by entering a checkout stage. For example, the consumer may check out 105 from a merchant's Web site after selecting one or more items for purchase. Alternately, the consumer may select a product and/or service for purchase using a portable device, which selection may initiate the disclosed payment process. Other methods of entering a checkout stage may also be performed within the scope of this disclosure.

The consumer may be requested to enter a consumer identifier as part of the checkout process. The consumer identifier may include, for example, and without limitation, an e-mail address, a mobile telephone number and/or any other identifier that uniquely identifies a consumer and/or a consumer's household.

The merchant and/or the merchant website may submit 110 the consumer identifier to a service platform, In an embodiment, the submission 110 of the consumer identifier to the service platform may be performed over a public network, such as the Internet and/or an intranet. In an embodiment, the submission 110 of the consumer identifier to the service platform may be performed over a private network.

The service platform may receive the consumer identifier and determine 115 whether the consumer identifier is contained within a service platform database. If the consumer identifier is not in the service platform database, the merchant may initially process 120 the payment in a conventional manner. For example, the merchant may request and receive a personal account number (PAN) and the consumer identifier from the consumer. The PAN and consumer identifier may be forwarded 125 to the service platform database to create a new entry for the consumer.

Once the PAN and consumer identifier have been received, the merchant may request 130 that the consumer authenticate the transaction and create a password for the service platform, which is forwarded to the service platform database. A determination may be made 135 as to whether the consumer has paid with, for example, a token device. If so, the password may be authenticated 140 by a token issuer. If not, the password may be authenticated 145 by the service platform. The consumer may then be requested to provide 175 a shipping address as described further below.

The stored password may be used in future transactions and authenticated by the appropriate entity as described above. In this manner, the consumer may be encouraged to enroll in the service platform database for future transactions.

Returning to the determination 115 of whether the consumer is in the service platform database, if the consumer has already registered with the service platform, a determination of whether the consumer is paying for the transaction with a token-enabled product or other third-party identity provider may be made 150. If so, the transaction may be authenticated 155 by the token issuer. If not, the transaction may be authenticated 160 by the service platform.

A determination may then be made 165 as to whether the desired shipping address is stored within the service platform database. For example, the consumer may be requested to select a shipping address from a list of previously supplied shipping addresses. If the desired shipping address is present in the list or is otherwise available for selection (such as if the desired shipping address corresponds to the billing address associated with the entry in the service platform database), the consumer may select 170 the particular shipping address from the service platform database. If the desired shipping address is not present, the consumer may provide 175 the proper shipping address to the merchant. The merchant may forward the shipping address to the service platform, which may record 180 the shipping address in the service platform database.

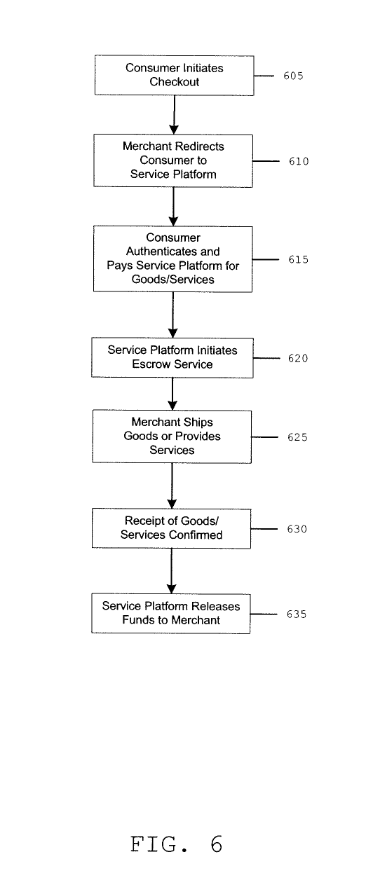

The service platform may optionally initiate 185 an escrow service. For example, the service platform may set aside an amount of money from the consumer to enable the payment. In this manner, the merchant may be certain that payment will be made for the purchased product and/or service. An exemplary escrow service is described in reference to FIG. 6 below.

The service platform may process 190 the payment for the transaction and provide confirmation to the merchant that the payment has been processed. The transaction may then complete 195.

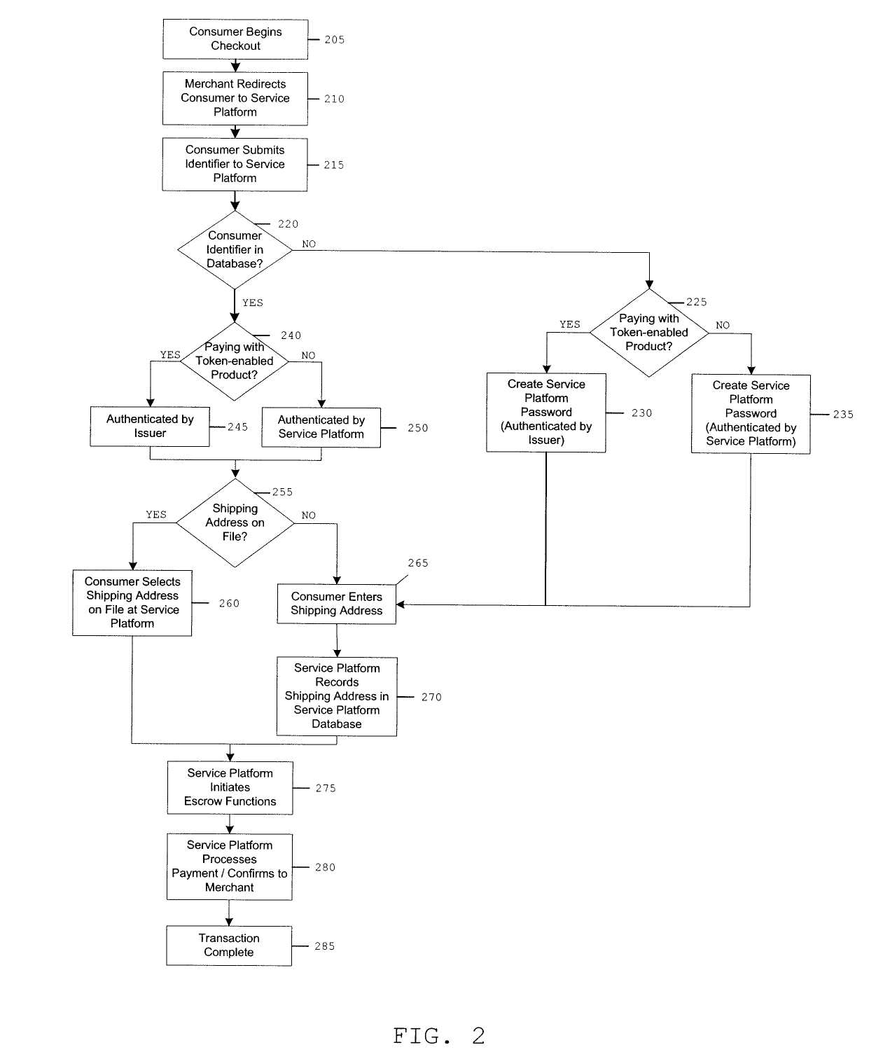

FIG. 2 depicts a flow diagram for an alternate exemplary method of facilitating a financial transaction according to an embodiment. As shown in FIG. 2, the merchant may provide a hosted gateway to the service platform at checkout instead of interacting with the service platform. In this manner, the amount of data transferred between the merchant and the service platform and the amount of data made available to the merchant directly may each be substantially reduced.

As shown in FIG. 2, a consumer may initiate 205 a checkout process. A merchant and/or a merchant website may redirect 210 the consumer to a service platform. The consumer may submit 215 a consumer identifier directly to the service platform. The service platform may determine 220 whether the consumer has account information entered in a service platform database by comparing the consumer identifier with values stored in one or more database entries. The service platform database may determine 225 whether the consumer has paid with a token. If so, a password may be authenticated 230 by a token issuer. If not, the password may be authenticated 235 by the service platform. The consumer may then be requested to provide 265 a shipping address as described further below.

Returning to the determination 220 of whether the consumer is in the service platform database, if the consumer has already registered with the service platform database, a determination of whether the consumer is paying for the transaction with a token-enabled product may be made 240. If so, the transaction may be authenticated 245 by the token issuer. If not, the transaction may be authenticated 250 by the service platform.

A determination may then be made 255 as to whether the desired shipping address is stored within the service platform database. For example, the consumer may be requested to select a shipping address from a list of previously supplied shipping addresses. If the desired shipping address is present in the list or is otherwise available for selection (such as if the desired shipping address corresponds to the billing address associated with the entry in the service platform database), the consumer may select 260 the particular shipping address from the service platform database. If the desired shipping address is not present, the consumer may provide 265 the proper shipping address to the merchant. The merchant may forward the shipping address to the service platform, which may record 270 the shipping address in the service platform database.

The service platform may optionally initiate 275 an escrow service. For example, the service platform may set aside an amount of money from the consumer to enable the payment. In this manner, the merchant may be certain that payment will be made for the purchased product and/or service. An exemplary escrow service is described in reference to FIG. 6 below.

The service platform may process 280 payment for the transaction and provide confirmation to the merchant that the payment has been processed. The transaction may then complete 285.

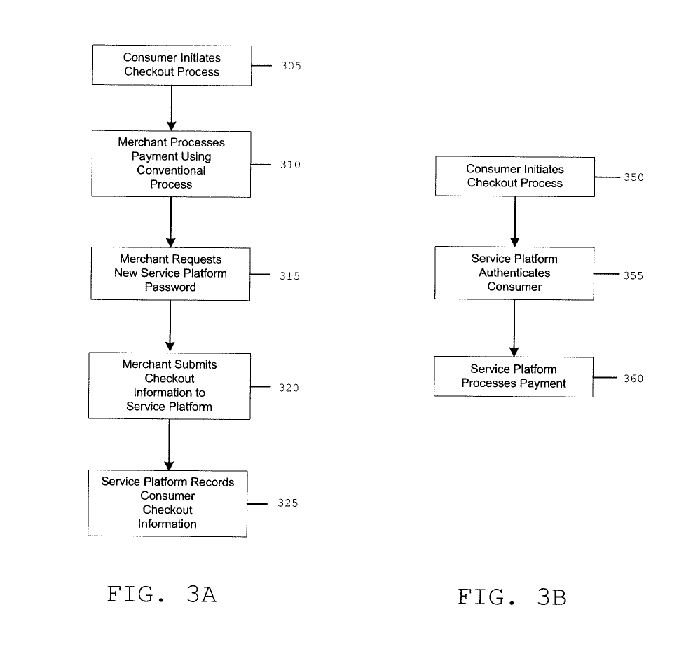

FIG. 3A depicts a flow diagram for an exemplary automatic enrollment process during a financial transaction according to an embodiment. As shown in FIG. 3A, a consumer may initiate 305 a checkout process by entering typical checkout information, such as an email address, a telephone number, a credit card # (i.e., a PAN), a shipping address, a billing address, a card verification value and/or other information. A consumer may also enter a consumer identifier, such as an email address, a phone number, at least a portion of a social security number, at least a portion of a home or billing address, a user-defined login name, an employee number, an identification number and/or the like, and the service platform password for the consumer. The consumer identifier may include partially or completely public information. If the consumer identifier includes public information, an authentication identifier may also be provided. Other consumer identifiers may also be used within the scope of the invention. In some cases, the checkout information and the information provided as the consumer identifier may overlap. In such cases, only one entry of the overlapping information may be required to process the transaction.

The merchant may receive the information and may initially process 310 the payment in a conventional manner. During or after the payment process, the merchant may request 315 that the consumer provide a password for a service platform. The merchant may transmit 320 the checkout information and password to a service platform that may record 325 the consumer enrollment information and password in a service platform database.

FIG. 3B depicts a flow diagram for an exemplary financial transaction after automatic enrollment has been performed according to an embodiment. As shown in FIG. 3B, subsequent transactions may be performed with the assistance of the service platform. The consumer may initiate 350 the checkout process by entering a consumer identifier, such as an email address, a phone number, at least a portion of a social security number, at least a portion of a home or billing address, a user-defined login name, an employee number, an identification number and/or the like, and the service platform password for the consumer. The consumer identifier may include partially or completely public information. If the consumer identifier includes public information, an authentication identifier may also be provided. Other consumer identifiers may also be used within the scope of the invention. In some cases, the checkout information and the information provided as the consumer identifier may overlap. In such cases, only one entry of the overlapping information may be required to process the transaction.

The service platform may authenticate 355 the consumer and process 360 the payment transaction. Accordingly, the transaction performed subsequent to the automatic enrollment process may be substantially streamlined over conventional financial transactions.

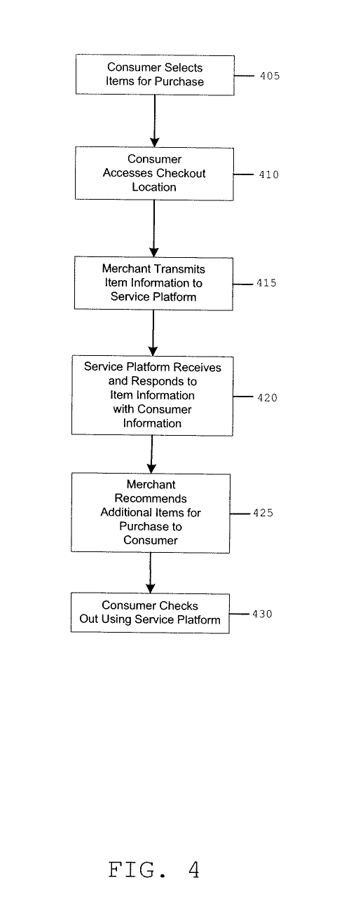

FIG. 4 depicts a flow diagram for an exemplary method of providing consumer purchase history data to a merchant during a financial transaction according to an embodiment. As shown in FIG. 4, a consumer may select 405 one or more items for purchase at a merchant site. The consumer may then access 410 a checkout location, such as a checkout Web page on a merchant's Internet site.

The merchant may transmit 415 information regarding the items that the consumer has selected to a service platform from the checkout location. The service platform may receive the item information and may respond 420 to the merchant with information pertaining to the consumer. In an embodiment, the information pertaining to the consumer may include one or more of the consumer's purchase history, such as the consumer's most recent purchases; the consumer's credit history, such as the consumer's credit-worthiness; and/or other consumer information. In an embodiment, the amount and/or type of information provided to the merchant may be limited to information permissible to be disclosed under governing privacy regulations.

The merchant may recommend 425 an additional product or service based on the information pertaining to the consumer, which the consumer may either accept or decline. The consumer may complete 430 a payment transaction with one or more of the merchant and the service platform.

In an embodiment, one or more additional items and/or upgrades may be available for an item previously purchased by the consumer. A service platform may report that the consumer has previously purchased the item to the merchant, and the merchant may determine that such additional items and/or upgrades should be suggested to the consumer for purchase. For example, if the consumer recently purchased a digital camera at another merchant that is enrolled with the service platform, the service platform may report such information to the merchant. The merchant may then suggest batteries for the camera as an item for purchase to the consumer. Alternately, the service platform may suggest that one or more products be offered for sale to a consumer based on previous purchases made by the consumer.

In an embodiment, consumer purchase history or credit history information may be used to offer a service with a transaction. For example, the service platform may inform the merchant that the consumer frequently purchases products across borders. The merchant may determine based on this information to offer an escrow service to the consumer for a current transaction. In an alternate embodiment, the service platform may prompt the merchant to provide an escrow service to the consumer without providing a reason why such service should be offered.

Additional and/or alternate products and/or services may also be offered based on information provided to the merchant by the service platform within the scope of this disclosure as will be apparent to those of ordinary skill in the art.

Accordingly, the information provided by the service platform may enable the merchant to provide a more complete product and/or service offering to the consumer. In addition, the information provided by the service platform may provide a customer with a more standardized purchasing experience when dealing with a plurality of merchants.

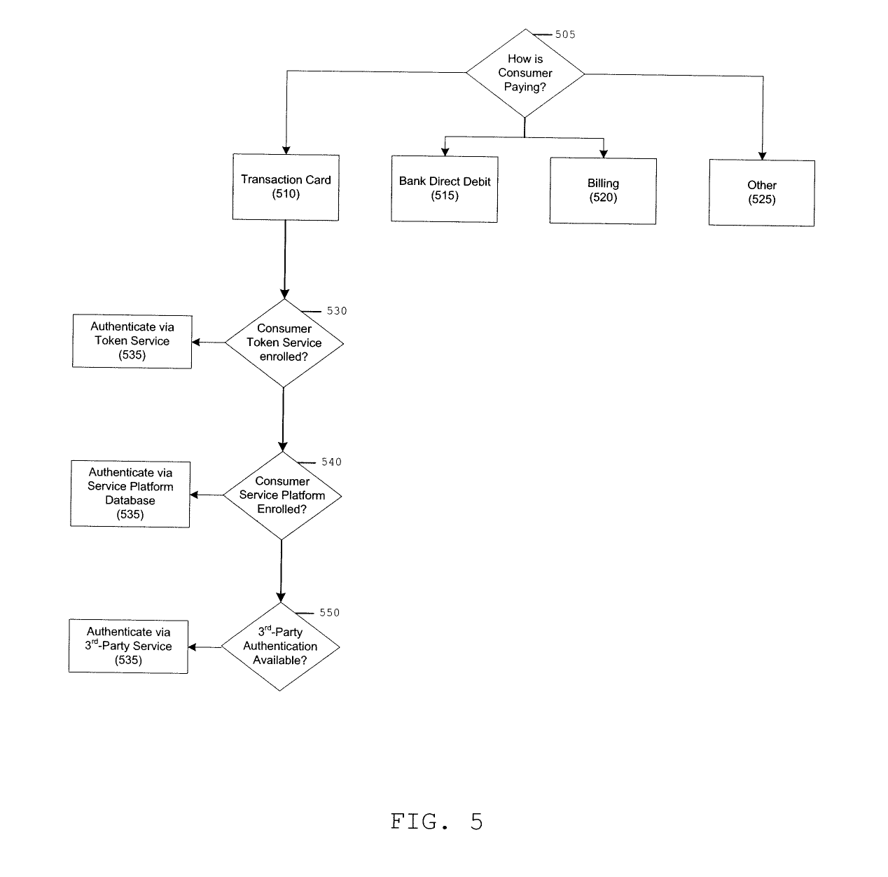

FIG. 5 depicts a flow diagram for an exemplary method of determining an authentication service for a transaction according to an embodiment. As shown in FIG. 5, a payment mechanism for a particular transaction may be determined 505. In an embodiment, the payment mechanism may correspond to a mechanism requested by a consumer. In an embodiment, potential payment mechanisms may include, for example and without limitation, a transaction card 510, such as a credit card, a debit card, a smart card and/or the like, a direct bank debit 515, billing the consumer 520, and/or any other payment methods or mechanisms 525 that a merchant or service provider offers.

If the payment mechanism is a transaction card 510, the authentication service may be determined based on consumer-specific information. For example, if it is determined 530 that the consumer is enrolled with a token-based service (or a similar service), authentication for the transaction may be performed 535 via the token-based service. If the consumer is not enrolled with a token-based service, but is enrolled 540 with a service platform, authentication for the transaction may be performed 545 using a service platform database. If the consumer is not enrolled with either a token-based service or a service platform and if third party authentication is available 550 to the consumer, authentication for the transaction may be performed 555 via the third party service. Alternate and/or additional methods of providing authentication may also be performed within the scope of this disclosure.

FIG. 6 depicts a flow diagram for an exemplary method of automatically providing an escrow function for a transaction according to an embodiment. In other words, an escrow service may be provided without a request being made by either a merchant or a consumer. Moreover, the escrow service may be transparent with respect to the purchase or payment flow.

As shown in FIG. 6, a consumer may initiate 605 a checkout process. A merchant and/or a merchant website may redirect 610 the consumer to a service platform. The consumer may authenticate the transaction and provide 615 payment to the service platform for the purchased goods and/or services. The service platform may initiate 620 an escrow service on behalf of the consumer upon receiving payment for the transaction. Because the escrow service is initiated at the time of payment, the consumer may have already requested that funds sufficient to receive the goods or services be assigned to the transaction via the service platform. Such funds may be placed in escrow with the service platform. As such, the merchant need not be concerned with whether the consumer has sufficient funds to pay for the requested goods and/or services because payment is confirmed at the time of purchase.

The merchant may ship 625 the purchased goods and/or provide the purchased services to the consumer. The consumer may confirm 630 receipt of the goods and/or services via any known means, such as SMS messaging, a phone call, an email message and the like. In an embodiment, a shipping agent may confirm 630 receipt of the goods or services by the consumer. For example, if the consumer is required to sign or otherwise provide identification to obtain possession of a good, the signature or other identification means may be provided to the service platform by the shipping agent as confirmation of receipt. Additional and/or alternate trusted third parties may also act as intermediaries that confirm receipt by the consumer within the scope of this disclosure. Moreover, additional and/or alternate methods of confirming receipt of the purchased goods and/or services are encompassed within the scope of this disclosure. Once the consumer's receipt is confirmed, the service platform may release 635 the escrowed funds to the merchant to complete the transaction.

Both the consumer and the merchant may benefit from engaging in a more efficient transaction by having the escrow service seamlessly inserted into the payment flow.

In an embodiment, a balance transfer may be performed as part of an enrollment process. For example, when a consumer enrolls with the service platform, a service platform provider may offer an incentive to the consumer to transfer a balance from a third party payment processor to the service provider. In an embodiment, the incentive may include a lower interest rate on transferred debt, receipt of a promotional item and/or the like. In an embodiment, a balance transfer process may permit instant transfer and acceptance of funds which is of mutual benefit to the two parties. As such, a service provider may provide a balance transfer process that is similar to balance transfers offered by credit card issuers, but in an online environment.

In an embodiment, the balance transfer may be offered to the consumer other than at the time of enrollment. For example, the service platform provider may offer a promotion in which all consumers that perform a transaction with a given time period are offered the ability to perform a balance transfer. Receipt of a promotional incentive may be conditioned upon transferring a balance. Other operations and times for performing such operations may also be performed within the scope of this disclosure.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A system for processing a purchase comprising:
a merchant for providing to a consumer an electronic shopping cart, providing to a consumer a prompt to enter a consumer identifier, and submitting content of the shopping cart and the consumer identifier for payment; and
a service platform for storing the consumer's payment information, receiving the content of the shopping cart and the consumer identifier, authenticating the consumer's the payment information, processing payment for the content of the shopping cart using the consumer's payment information, and sending confirmation of payment to the merchant.

2. The system of claim 1, wherein the payment information comprises an account number and a shipping address.

3. The system of claim 1, wherein if the consumer's payment is tendered using a token-enabled product, the authentication of the consumer's payment information is performed with the token issuer.

4. The system of claim 1, wherein the service platform further provides to a consumer a prompt to enter a password.

5. A method of processing a purchase comprising:
storing a consumer's payment information, the payment information comprising an account number;
receiving a checkout request from a merchant, the checkout request comprising an item to be purchased by the consumer;
receiving a consumer identifier;
processing the payment for the item using the payment information corresponding to the consumer identifier; and
transmitting confirmation of payment processing to the merchant.

6. The method of claim 5, wherein the consumer identifier is received together with the checkout request.

7. The method of claim 5, further comprising providing to the consumer a prompt to enter a consumer identifier.

8. The method of claim 5, further comprising providing to the consumer a prompt to enter a password.

9. The method of claim 5, further comprising authenticating the consumer's payment information.

10. The method of claim 9, wherein the consumer's payment information is authenticated with a token issuer if the user is paying with a token-enabled product.

11. The method of claim 5, wherein the payment information further comprises a shipping address.

12. The method of claim 5, further comprising initiating an escrow service.

13. A method of processing a purchase comprising:
storing consumer information associated with a consumer;
receiving from a transacting merchant the identity of an item to be purchased by a consumer and information sufficient to identify the consumer;
transmitting, to the transacting merchant, information associated with the consumer;
receiving a check-out request from the merchant, the check-out request comprising the identity of the item; and
processing payment for the item.

14. The method of claim 13, wherein the information associated with the consumer comprises the identity of a good or a service purchased by the customer in the past, wherein the good or service purchased by the consumer was purchased from a merchant other than the transacting merchant.

15. The method of claim 13, wherein the information associated with the consumer comprises the consumer's credit history.

16. A method of processing a purchase comprising:
storing a consumer's payment information, the payment information comprising an account number;
receiving a checkout request from a merchant after the consumer's payment information is stored, the checkout request comprising an item to be purchased by the consumer;
receiving a consumer identifier associated with the consumer;
processing and receiving payment for the item using the consumer's payment information;
transmitting confirmation of receipt of payment to the merchant;
receiving confirmation that the consumer received the item; and
releasing payment for the item to the merchant after receiving confirmation of receipt that the consumer received the item.

17. The method of claim 16, wherein the consumer identifier is received together with the checkout request.

18. The method of claim 16, further comprising providing to the consumer a prompt to enter a consumer identifier.

19. The method of claim 16, further comprising providing to the consumer a prompt to enter a password.

20. The method of claim 16, further comprising authenticating the consumer's payment information.

21. The method of claim 16, wherein the consumer's payment information is authenticated with a token issuer if the user is paying with a token-enabled product.

22. The method of claim 16, wherein the payment information further comprises a shipping address.
